(19) United States
(12) Patent Application Publication
(10) Pub. No.: US 2023/0069285 A1
(43) Pub. Date: Mar. 2, 2023

(54) COGNITIVE SCRUM MASTER ASSISTANCE INTERFACE FOR DEVELOPERS

(71) Applicant: Bank of America Corporation, Charlotte, NC (US)

(72) Inventors: Tamilselvi Elango, Chennai (IN); Karthikeyan Janakiraman, Tamil Nadu (IN)

(21) Appl. No.: 17/406,366

(22) Filed: Aug. 19, 2021

(51) Int. Cl. G06Q 10/10; G06Q 10/06; G06N 3/04; G06N 3/08; G06F 40/56

(52) U.S. Cl. CPC G06Q 10/101; G06Q 10/103; G06Q 10/06313; G06Q 10/0637; G06N 3/0445; G06N 3/08; G06F 40/56

(57) ABSTRACT

Apparatus and methods for producing a product. The method may include receiving from a development assistance platform: a plurality of natural language state text segments; and a plurality of natural language action text segments. The method may include deriving for each of the plurality of natural language state text segments a state vector. The method may include deriving for each of the plurality of natural language action text segments an action vector. The method may include selecting, based on the state text segments, from the action vectors, an action vector corresponding to a past reward. The method may include designating a current reward based on the action vector. The method may include transmitting a directive to a development resource. The method may include deriving for the directive a directive vector. The method may include providing the directive vector to the platform.

### BACKGROUND

Typical product development involves sharing of information between team developers and team leaders. The information is typically voluminous and requires rapid and complex decision making to guide a team through the product development process. Different frameworks have been proposed to guide team leaders through the product development process. Team leaders may benefit from objective analysis of fact patterns and historical decision-making, but no such approach is available.

It would therefore be desirable to provide apparatus and methods for product development.

### SUMMARY

Apparatus and methods for producing a product. The method may include receiving from a development assistance platform: a plurality of natural language state text segments; and a plurality of natural language action text segments. The method may include deriving for each of the plurality of natural language state text segments a state vector. The method may include deriving for each of the plurality of natural language action text segments an action vector. The method may include selecting, based on the state text segments, from the action vectors, an action vector corresponding to a past reward. The method may include designating a current reward based on the action vector. The method may include transmitting a directive to a development resource. The method may include deriving for the directive a directive vector. The method may include providing the directive vector to the platform.

### BRIEF DESCRIPTIONS OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus in accordance with principles of the invention.

FIG. 2 shows illustrative apparatus in accordance with principles of the invention.

FIG. 3 shows an illustrative schema in accordance with principles of the invention.

FIG. 4 shows illustrative apparatus in accordance with principles of the invention.

FIG. 5 shows illustrative apparatus in accordance with principles of the invention.

FIG. 6 shows an illustrative process in accordance with principles of the invention.

The leftmost digit (e.g., “L”) of a three-digit reference numeral (e.g., “LRR”), and the two leftmost digits (e.g., “LL”) of a four-digit reference numeral (e.g., “LLRR”), generally identify the first figure in which a part is called-out.

### DETAILED DESCRIPTION

In product development, a “scrum” of developers may participate in the production of a product. The developers formulate “stories” that articulate succinct goals that would contribute to the product. Each story is evaluated with “points” that express how much time it will take to accomplish the goal. Points may depend on scope, complexity or other factors. The scrum master helps the scrum members refine the stories, and revise the points, based on the scrum master's experience, to fit into a development timeline that is a finite number of weeks.

The scrum master serves a development team in several ways, which may include:

Coaching the development team in organizational environments in which scrum is not yet fully understood.
Ensuring the scrum values, manifesto values and principles are understood and applied in the scrum.
Removing impediments to the development team's progress.
Guiding the team to write and break down user stories with acceptance criteria.

A scrum master may act as a guide for the developers during release, sprint planning, daily standups, sprint retrospectives and reporting needs.

The apparatus and methods may take textual input, use reinforcement learning for decision making, and may generate textual response that is dynamic in nature.

The apparatus and methods may be added as a plugin to an existing lifecycle management tool.

The apparatus and methods may save manual effort and time to assist the team members.

The apparatus and methods may use archived development data to create, based on reinforcement learning, a digital scrum master agent that is capable of developing directives for the scrum members to improve the likelihood that the scrum will meet its goal within a sprint. The apparatus and methods may use deep reinforcement learning to learning to assist and guide a scrum master. A reinforcement learning (“RL”) agent may serve as a scrum master for a task the RL agent has mastered. The agent needs may have access to voluminous information related to a project from a lifecycle management tool. The scrum master agent (a machine) may assist a human agent by suggesting actions the latter should do while doing a specific task

Apparatus and methods for producing a product are provided.

The apparatus may include a bidirectional recurrent neural network encoder-decoder.

The apparatus and method may include a method for producing a product. The method may include receiving from a development assistance platform: a plurality of natural language state text segments; and a plurality of natural language action text segments. The method may include deriving for each of the plurality of natural language state text segments a state vector. The method may include deriving for each of the plurality of natural language action text segments an action vector. The method may include selecting, based on the state text segments, from the action vectors, an action vector corresponding to a past reward. The method may include designating a current reward based on the action vector. The method may include transmitting a directive to a development resource. The method may include deriving for the directive a directive vector. The method may include providing the directive vector to the platform.

The apparatus may include a reinforcement learning engine.

The reinforcement learning engine may be based on a teacher student framework in reinforcement learning. In this framework, a teacher agent instructs a student agent by suggesting actions the student should take as it learns. However, a scrum master who assist the team cannot give unlimited number of suggestions or instruction. Equation 1 gives an illustrative reward framework:

$${R}_{teacher} ( s , a ) = \{ \begin{matrix}{r}_{max} - {n}_{step} / {r}_{d} , If student reached goal \\ - 1 , Otherwise\end{matrix} , \qquad Eq ’ n 1$$

where nₛₜₑₚ is the number of time steps that a student needed to reach a goal state, positive constant rₘₐₓ is the greatest award obtainable, and r_{d} is a positive constant such that the maximum number of time steps of an episode divided by rd is less than rₘₐₓ.

The framework may be embedded in a larger context involving mistake correction and predictive advising. Mistake correcting is used when the student makes a mistake. Predictive advising is used even when teachers cannot directly access a student's knowledge. The teacher, however, may be able to infer students' policies from the students' behavior. A teacher may observe the states that a student encounters and the actions the student adopts. Using these observations as training data, the teacher can train a classifier to predict student actions, and use these predictions in place of student announcements or actions, thus skipping steps.

The input text from the tool may be considered the state-space for the predictive model. The action space may be considered to include every text combination available in a data lake. The training may proceed as follows:

Agent observes state as a string of text at a time t, e.g., state-text s(t).
Agent also knows a set of possible actions, each describes as a string text, e.g, action-texts
Agent tries to understand the “state text” and all possible “action texts”, and takes to right action—right means maximizing the long term reward.
Then, the environment state transits to a new state, agent receives an immediate reward.

The reinforcement learning engine may be configured to receive from the encoder-decoder: a state vector; and an action vector. The reinforcement learning engine may be configured to determine a directive based on: the state vector; and the action vector. The reinforcement learning engine may be configured to identify a complexity error condition in the directive. The reinforcement learning engine may be configured to identify a coherence error condition in the directive. The reinforcement learning engine may be configured to receive a human-based reward. The reinforcement learning engine may be configured to return the directive and the human-based reward to the encoder-decoder.

The bidirectional recurrent neural network encoder-decoder may be configured to incorporate into a neural network the human-based reward.

The learning engine may be configured to evaluate the action vector based on a reward matrix developed from output from the neural network.

The action vector may be an observed action vector. The learning engine may be configured to evaluate the observed action vector by determining a difference in the matrix between: a first reward based on the observed action vector; and a second reward. The second reward may be based on a preferred action vector derived from the matrix prior to receipt of the observed action vector.

The reinforcement learning engine may be configured to transmit the directive to a development resource. The development resource may be a scrum board. The development resource may be a product development team member.

The methods may include receiving from a development assistance platform a plurality of natural language state text segments. The methods may include receiving from a development assistance platform a plurality of natural language action text segments. The methods may include receiving from a development assistance platform deriving for each of the plurality of natural language state text segments a state vector. The methods may include deriving for each of the plurality of natural language action text segments an action vector. The methods may include selecting, based on the state text segments, from the action vectors, an action vector corresponding to a past reward. The methods may include designating a current reward based on the action vector. The methods may include transmitting a directive to a development resource. The methods may include deriving for the directive a directive vector. The methods may include providing the directive vector to the platform.

The directive may include a mistake correction based on a proposed development action. The directive may include predictive advice based on the state text segments.

The deriving may include formulating a generic response corresponding to the action. The formulating may include mapping the action to one of a plurality of pre-selected generic responses. The mapping may include choosing from the plurality of pre-selected generic responses the pre-selected generic response that is most likely to cause the action.

The reward may include a machine-determined reward component that is based on historical data. The reward may include a human-determined reward component.

The methods may include generating, from the state text segments, a prediction of the action. The methods may include comparing the action to the prediction. The methods may include rejecting the action based on the comparing.

The methods may include receiving from a development assistance platform natural language text segments. The methods may include deriving, using natural language understanding (“NLU”), from the text segments: a state vector; and an observed action vector. The methods may include formulating, based on the state, a preferred vector action. The methods may include determining a difference between the observed action vector and the preferred action vector. The methods may include selecting, based on the difference, an assistance mode from the group consisting of: mistake correcting; and predictive advising. The methods may include determining a directive vector based on the assistance mode. The methods may include converting the directive vector, using natural language generation (“NLG”), to directive text. The methods may include communicating the directive text to a development resource. The methods may include providing the directive vector to the platform. The methods may include receiving a human reward based on the directive text. The methods may include transmitting the reward to the platform.

The methods may include, prior to the communicating, performing a complexity analysis on the directive text. The methods may include, prior to the communicating, performing a coherence analysis on the directive text.

The methods may include formulating a reward matrix based on: a plurality of state vectors; and a plurality of actions, each action associated with one of the state vectors.

The determining may include quantifying a first reward based on the observed action. The determining may include quantifying a second reward based on the preferred action.

The methods may include computing the second reward using a recurring neural network that includes the human reward.

An architecture for the apparatus and methods may include a first layer, a second layer and a third layer. Table 1 lists illustrative layers.

TABLE 1
Illustrative layers

| Illustrative layer | Illustrative characteristics |
|---|---|
| First layer | Natural language understanding (“NLU”); |
| | digests development tool communications |
| Second layer | Training of scrum master; creation of RL |
| | agent; learn to assist/teach; reinforcement |
| | learning; monitor activities of scrum tool; |
| | provide assistance to human agent; update |
| | scrum board |
| Third layer | Natural Language Generation; scrum master |
| | interacts with human; textual |
| | communications; use RL and NL processing; |
| Other suitable layers | Other suitable characteristics |

Reinforcement learning may be used for language understanding and language generation, for example, in the translation between message text and vector data.

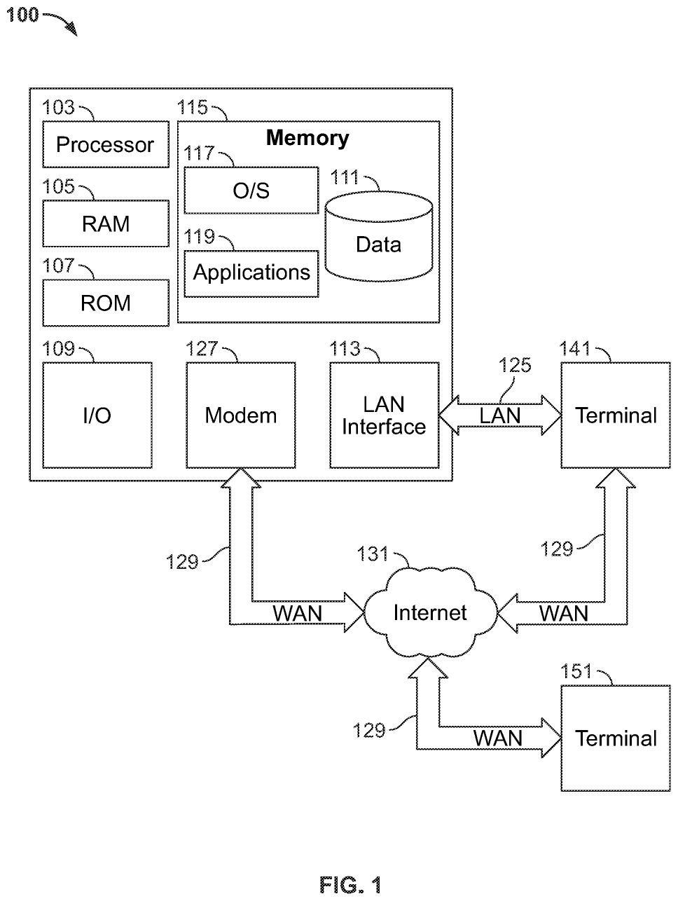

FIG. 1 is a block diagram that illustrates a computing server 101 (alternatively referred to herein as a “server or computer”) that may be used in accordance with the principles of the invention. The server 101 may have a processor 103 for controlling overall operation of the server and its associated components, including RAM 105, ROM 107, input/output (“I/O”) module 109, and memory 115.

I/O module 109 may include a microphone, keypad, touchscreen and/or stylus through which a user of server 101 may provide input, and may also include one or both of a speaker for providing audio output and a video display device for providing textual, audiovisual and/or graphical output. Software may be stored within memory 115 and/or other storage (not shown) to provide instructions to processor 103 for enabling server 101 to perform various functions. For example, memory 115 may store software used by server 101, such as an operating system 117, application programs 119, and an associated database 111. Alternatively, some or all of computer executable instructions of server 101 may be embodied in hardware or firmware (not shown).

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks.

When used in a LAN networking environment, server 101 is connected to LAN 125 through a network interface or adapter 113.

When used in a WAN networking environment, server 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system may be operated in a client-server configuration to permit a user to retrieve web pages from a web-based server. Any of various conventional web browsers may be used to display and manipulate data on web pages.

Additionally, application program 119, which may be used by server 101, may include computer executable instructions for invoking user functionality related to communication, such as email, short message service (SMS), and voice input and speech recognition applications.

Computing server 101 and/or terminals 141 or 151 may also be mobile terminals including various other components, such as a battery, speaker, and antennas (not shown). Terminal 151 and/or terminal 141 may be portable devices such as a laptop, tablet, smartphone or any other suitable device for receiving, storing, transmitting and/or displaying relevant information.

Any information described above in connection with database 111, and any other suitable information, may be stored in memory 115. One or more of applications 119 may include one or more algorithms that may be used to perform the functions of one or more of a scrum master agent and perform any other suitable tasks.

The apparatus and methods may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The apparatus and methods may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

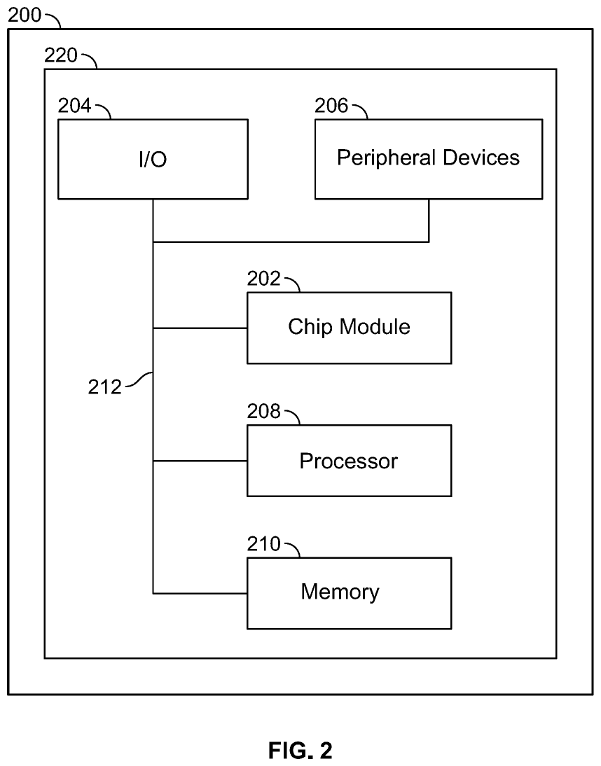

FIG. 2 shows illustrative apparatus 200 that may be configured in accordance with the principles of the invention.

Apparatus 200 may be a computing machine. Apparatus 200 may include one or more features of the apparatus that is shown in FIG. 1.

Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may solve equations and perform other methods described herein; and machine-readable memory 210.

Machine-readable memory 210 may be configured to store in machine-readable data structures associated with a scrum and any other suitable information or data structures.

Components 202, 204, 206, 208 and 210 may be coupled together by a system bus or other interconnections 212 and may be present on one or more circuit boards such as 220. In some embodiments, the components may be integrated into a single chip.

The chip may be silicon-based.

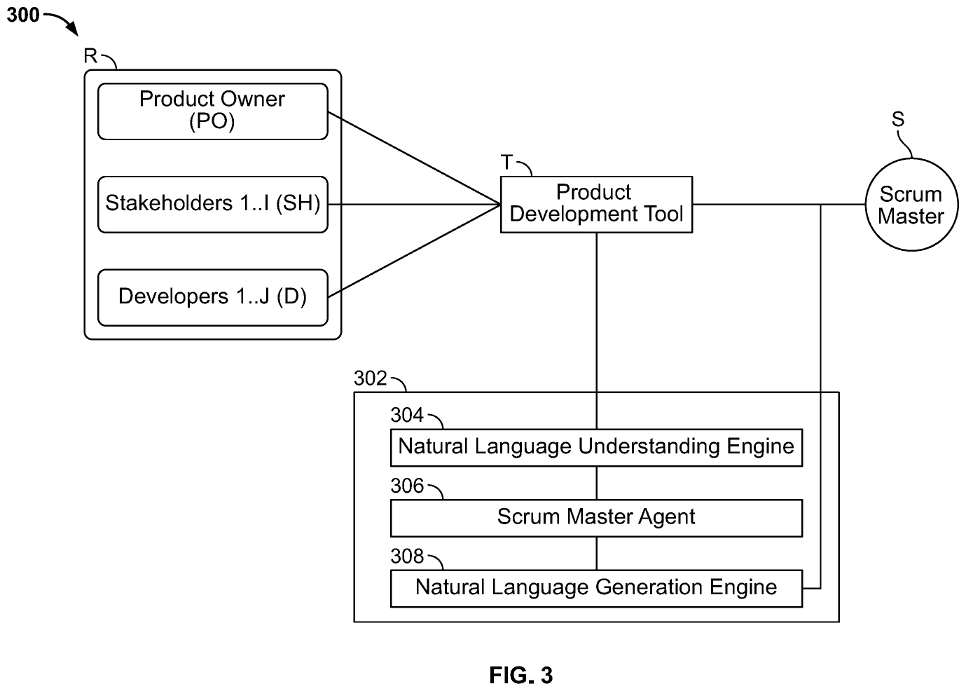

FIG. 3 shows illustrative architecture 300 for producing a product. Architecture 300 may include resources R. Architecture 300 may include product development tool T. Architecture 300 may include human scrum master S. Architecture 300 may include assistance interface 302.

Resources R may include product owner PO. Resources R may include stakeholders SH. Resources R may include developers D.

Tool T may include features of product development tools such as those that are commercially available. Table 2 lists illustrative tradenames under which such tools may be obtained.

TABLE 2
Illustrative tools

Monday
Hive
Task
Nutcache
Clarizen
Project Manager
Jira
Targetprocess
ClickUp
Vivifyscrum
Other suitable tools

A resource R may exchange product development information items with tool T. Tool T may provide product development functions in connection with the product development information items. Table 3 lists illustrative product development information items and illustrative product development functions.

TABLE 3
Illustrative functions and product development information items

| Illustrative product | Illustrative product |
|---|---|
| development information items | development functions |
| Product development project | Define product development |
| parameters | project |
| Participant identification | Register participants |
| Epic | Draft epic |
| Story | Draft story |
| Story point | Draft story point |
| Story backlog | Make backlog |
| Backlog priority | Prioritize backlog items |
| Meeting coordinates | Schedule meeting |
| Message | Receive message |
| | Transmit message |
| Sprint information | Define sprint timeline |
| Action item | Define action item |
| Event (e.g., standup) | Schedule event |
| Milestone | Schedule milestone |
| Velocity | Calculate velocity |
| Completion date | Project completion date |
| Deliverable | Define deliverable |
| Product | Define product |
| Scrum board information | Provide scrum board information |
| Other suitable information | Other suitable product development |
| items | functions |

Resources R, scrum master S and agent 302 may communicate with tool T via text, voice or other suitable messaging approach.

Scrum master S may coach a resource R to develop a product by a defined deadline.

Interface 302 may be registered in tool T as a participant in a product development project. Interface 302 may include an administrative module. Scrum master S may use the administrative module to register interface 306 in tool T.

Interface 302 may include natural language understanding engine 304. Interface 302 may include scrum master agent 306. Interface 302 may include natural language generation engine 308.

Natural language understanding engine 304 may receive a text from tool T. The text may include a product development information item. Natural language understanding engine 304 may encode the item. Natural language understanding engine 304 may provide the encoded item to scrum master agent 306. Scrum master agent 306 may formulate an assistive product development information item based on machine learning. Table 4 lists illustrative assistive product development information.

TABLE 4
Illustrative assistive product development information

| | |
|---|---|
| Missing product development | Resource XYZ action item missing |
| project information | for story point ABC |
| See project no. XYZ | Resource XYZ is over-assigned based |
| | on past performance |
| Register resource as member | Resource XYZ is under-assigned based |
| of product development team | on past performance |
| Epic text incomplete | Milestone warning: forecast velocity, |
| | based on team past performance too slow |
| Epic text insufficiently | Get sprint status on story point XYZ |
| tied to project | |
| Break epic into stories | Remove blockage of story point ABC by |
| | story point XYZ |
| Too many story points | Warning: conflict between story point |
| | ABC and story point XYZ |
| Too few story points | Warning: new requirement from product |
| | owner; advise product owner; move to |
| | product backlog |
| Story text incomplete | Reprioritize product backlog |
| Story text insufficiently | Get product owner approval of product |
| tied to project | backlog reprioritization |
| Time to fill backlog | Next sprint approaching: organize |
| | product backlog for next sprint |
| Time to prioritize product | Sprint not converging in time; |
| backlog | communicate with resources XYZ and |
| | ABC |
| Time to update product | Sprint converging: prepare to ship |
| backlog | product |
| Schedule a product backlog | Spring converging: double check |
| meeting | completion of action items |
| Groom product backlog | Warning: enterprise data security |
| | issue flagged in resource communication |
| Schedule a sprint meeting | Warning: Insufficient conformance of |
| | sprint to agile manifesto detected |
| | based on comparison with historical |
| | sprints of this and other teams |
| Enter a sprint backlog item | Warning: Insufficient conformance of |
| | sprint to agile principle detected |
| | based on comparison with historical |
| | sprints of this and other teams |
| Assign story point XYZ to | Other assistive product development |
| a resource | information |

The assistive product development information item may include a directive. Natural language generation engine 308 may decode the assistive product development information into a natural language text. Interface 302 may provide the natural language text to tool T. Interface 302 may provide the natural language text to scrum master S.

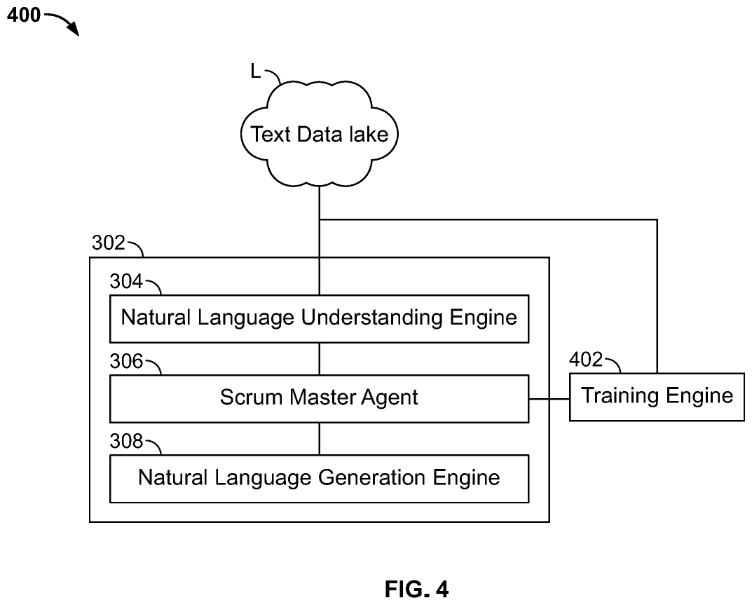

FIG. 4 shows illustrative architecture 400 for training scrum master agent 306. In architecture 400, interface 302 may be isolated from resources R, tool T and scrum master S. Text data lake may include textual transcripts of historical product development information from projects involving resources such as R, tools such as T and scrum masters such as S. Each project may have a timeline.

Training engine 402 may define states of the projects at different times on the timeline. Training engine 402 may identify actions taken by scrum masters in response to the different states. Training engine 402 may assign to each project an outcome. The outcome may be an indicator of the success of the project. The outcome may be numerical, categorical, qualitative, or any other suitable data type. Table 5 lists illustrative quantities on which the success may be based.

TABLE 5
Illustrative quantities

Product shipment by end of sprint timeline
Product owner rating of product
Budget overshoot
Budget undershoot
Velocity
Likelihood of conflict resolution during sprint
Likelihood of blockage removal during sprint
Timeliness of transition to new sprint
Likelihood of avoiding complex communications
between resources or resources and human scrum master
Likelihood of avoiding resource dissension
Product produced (goal reached)
Other suitable quantities

Training engine 402 may present a state to scrum master agent 306. Training engine 402 may present some or all of the actions from the lake to scrum master agent 306. Scrum master agent 306 may select from actions one action. Training engine 402 may derive from the lake a hypothetical outcome based on the state and the action selected by scrum master agent 306. Training engine 402 may compare the outcome to a most preferable outcome. Training engine 402 may reward scrum master agent 306 based on a difference between the hypothetical outcome and the preferred outcome. The difference may be inversely related to the reward. In this way, scrum master agent 306 may learn to choose actions that lead to preferred outcomes. Training engine 402 may apply any suitable training framework, including the teacher-student framework discussed above, to scrum master agent 306.

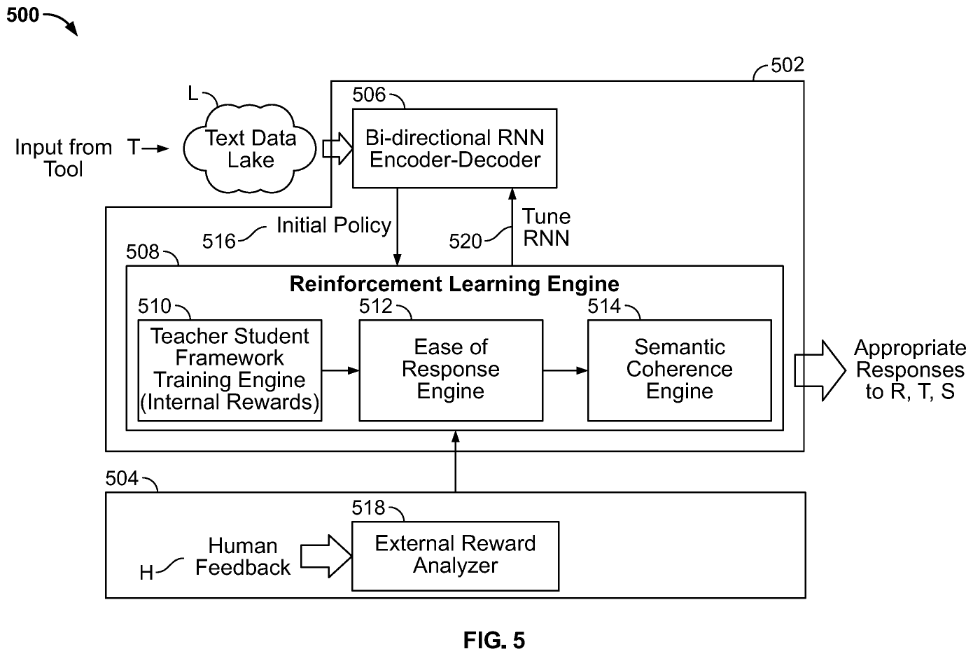

FIG. 5 shows illustrative architecture 500 for producing a product. Architecture 500 may include data input from tool T. Architecture 500 may include data held in lake L. Architecture 500 may include assistance interface 502. Assistance interface 502 may have one or more features in common with assistance interface 302. Architecture 500 may include external feedback layer 504.

Assistance interface 502 may include bi-directional RNN (recurrent neural network) encoder-decoder 506. Assistance interface 502 may include reinforcement learning engine 508. Encoder-decoder 506 may have one or more functions in common with natural language understanding engine 304. Encoder-decoder 506 may have one or more functions in common with natural language generation engine 308.

Reinforcement learning engine 508 may include teacher student framework training engine 510. Reinforcement learning engine 508 may include ease of response engine 512. Reinforcement learning engine 508 may include semantic coherence engine 514.

Teacher student training engine 510 may include a scrum master agent such as scrum master agent 306. The scrum master agent of teacher student training engine 510 may receive reward-based training based on initial policy 516. Initial policy 516 may include states and actions such as those administered by training engine 402. Supplemental policy may be provided from text data lake L after text data lake L receives supplemental text data from tools such as tool T. The scrum master agent of teacher student training engine 510 may provide “live” assistance to resources R, tool T and scrum master S. The live assistance may include assistive product development information. Encoder-decoder 506 (along channel not shown) may translate assistive product development information in vector for to natural language text.

Ease of response engine 512 may identify a complexity error condition in the directive. The complexity error condition may be triggered by excessive length of a text message. The complexity error condition may be triggered by use of use of conditional clauses in the text message. The complexity error condition may be triggered by vague terminology or syntax in the text message. The complexity error condition may be triggered by subjective terminology or syntax in the text message.

Semantic coherence engine 514 may identify a coherence error condition in the text message.

When a complexity error or a coherence error are identified, reinforcement learning engine 508 may provide feedback to encoder-decoder 506 to improve translations between text and vector representations of the text, and vice-versa.

Ease of response may be quantified as a likelihood of generating a target response (T) given the current state (S). Equation 2 sets forth such a likelihood:

\hat{T}=arg max|_{T}{log p(T|S)} Eq'n. 2

Complexity may be quantified as a semantic coherence. Semantic coherence may be used to avoid situations in which a generated responses lacks grammatical correctness or coherency. This may involve reverse-training the model to count the probability of the input prompt given the current generated responses. Equation 3 sets forth an illustrative coherency metric:

$${r}_{SC} = \frac{1}{{N}_{y}} log {p}_{seq 2 seq} ( y \vert {x}_{i} ) + \frac{1}{{N}_{{x}_{i}}} log {p}_{backward - seq 2 seq} ( {x}_{i} \vert y ) \qquad Eq ’ n . 3$$

External feedback layer 504 may include human feedback H. External feedback layer 504 may include external reward analyzer 518.

Human feedback H may correspond to a human. The human may be an experienced scrum master. The human may be scrum master S.

External reward analyzer 518 may present to human feedback H a project state and a corresponding assistive action item output by reinforcement learning system 508. Human feedback H may input into external reward analyzer a corrective assistive action item corresponding to the state. External reward analyzer 518 may generate a reward based on a difference between the corrective assistive action item and the assistive action item output by reinforcement learning system 508.

External reward analyzer 518 may provide the reward to reinforcement learning system 508. Reinforcement learning system 508 may transmit the reward, in association with the corresponding state and the corresponding assistive action item output by reinforcement learning system 508, to encoder-decoder 506.

Reinforcement learning system 508 may transmit to encoder-decoder 506 feedback 520. Feedback 520 may be based in whole or in part on a reward from external reward analyzer 518. Feedback 520 may be based in whole or in part on information from reinforcement learning system 508. Feedback 520 may be based in whole or in part on information from ease of response engine 512. Feedback 520 may be based in whole or in part on information from semantic coherence engine 514.

Feedback 520 may include feedback that may be used to improve translation, by encoder-decoder 506, between vector and text or between text and vector. This may help tune the recurrent neural network.

Training engine 402 may compare the outcome to a most preferable outcome. Training engine 402 may reward scrum master agent 306 based on a difference between the hypothetical outcome and the preferred outcome. The difference may be inversely related to the reward. In this way, scrum master agent 306 may learn to choose actions that lead to preferred outcomes. Training engine 402 may apply any suitable training framework, including the teacher-student framework discussed above, to scrum master agent 306.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

For the sake of illustration, the steps of the illustrated processes will be described as being performed by a “system.” A “system” may include one or more of the features of the apparatus and schemae that are shown in FIG. 1-FIG. 5 and/or any other suitable device or approach. The “system” may include one or more means for performing one or more of the steps described herein.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative process may include steps shown in connection with another illustrative process.

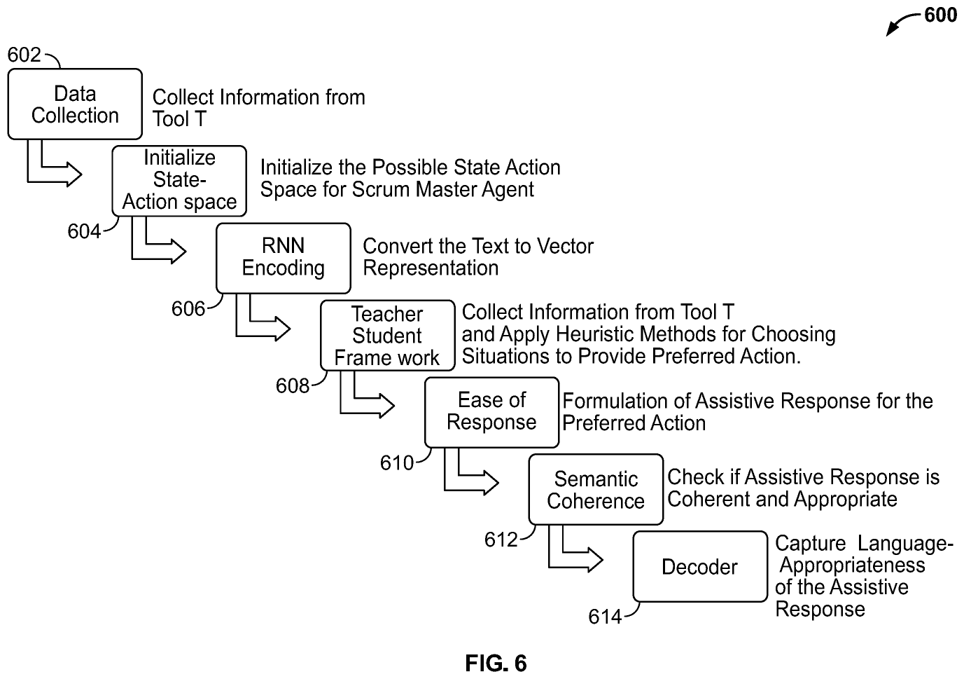

FIG. 6 shows illustrative process 600 for developing a product. Process 600 may start at step 602. At step 602 the system may collect project information, in text format, from a tool such as T. At step 604 the system may initialize the possible state-action space for presentation to a scrum master agent. At step 606 the system may convert the text to vector representation. At step 608 the system may collect project information from tool T and apply heuristic methods for choosing situations to provide a preferred action. At step 610 the system may formulate an assistive response for the preferred action. At step 612 the system may check if the assistive response is coherent and appropriate. At step 614 the system may capture, as feedback, the language appropriateness of the assistive response.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Thus, methods and apparatus for developing a product have been provided. Persons skilled in the art will appreciate that the present invention may be practiced by other than the described embodiments, which are presented for purposes of illustration rather than of limitation.

What is claimed is:

1. Apparatus for producing a product, the apparatus comprising:
a bidirectional recurrent neural network encoder-decoder;
a reinforcement learning engine configured to:
receive from the encoder-decoder:
a state vector; and
an action vector;
determine a directive based on:
the state vector; and
the action vector;
identify a complexity error condition in the directive;
identify a coherence error condition in the directive;
receive a human-based reward; and
return the directive and the human-based reward to the encoder-decoder.

2. The apparatus of claim 1 wherein the bidirectional recurrent neural network encoder-decoder is configured to incorporate into a neural network the human-based reward.

3. The apparatus of claim 2 wherein the learning engine is configured to evaluate the action vector based on a reward matrix developed from output from the neural network.

4. The apparatus of claim 3 wherein:
the action vector is an observed action vector; and
the learning engine is configured to evaluate the observed action vector by determining a difference in the matrix between:
a first reward based on the observed action vector; and
a second reward based on a preferred action vector derived from the matrix prior to receipt of the observed action vector.

5. The apparatus of claim 1 wherein:
the reinforcement learning engine is further configured to transmit the directive to a development resource; and
the development resource is a scrum board.

6. The apparatus of claim 1 wherein:
the reinforcement learning engine is further configured to transmit the directive to a development resource; and
the development resource is a product development team member.

7. A method for producing a product, the method comprising:
receiving from a development assistance platform:
a plurality of natural language state text segments; and
a plurality of natural language action text segments;
deriving for each of the plurality of natural language state text segments a state vector;
deriving for each of the plurality of natural language action text segments an action vector;
selecting, based on the state text segments, from the action vectors, an action vector corresponding to a past reward;
designating a current reward based on the action vector;
transmitting a directive to a development resource;
deriving for the directive a directive vector; and
providing the directive vector to the platform.

8. The method of claim 7 wherein the directive includes a mistake correction based on a proposed development action.

9. The method of claim 7 wherein the directive includes predictive advice based on the state text segments.

10. The method of claim 7 wherein the deriving includes formulating a generic response corresponding to the action.

11. The method of claim 10 wherein the formulating includes mapping the action to one of a plurality of pre-selected generic responses.

12. The method of claim 11 wherein the mapping includes choosing from the plurality of pre-selected generic responses the pre-selected generic response that is most likely to cause the action.

13. The method of claim 7 wherein the reward includes a machine-determined reward component that is based on historical data.

14. The method of claim 13 wherein the reward further includes a human-determined reward component.

15. The method of claim 7 further comprising:
generating, from the state text segments, a prediction of the action;
comparing the action to the prediction; and
rejecting the action based on the comparing.

16. A method for producing a product, the method comprising:
receiving from a development assistance platform natural language text segments;
deriving, using natural language understanding (“NLU”), from the text segments:
a state vector; and
an observed action vector;
formulating, based on the state, a preferred vector action;
determining a difference between the observed action vector and the preferred action vector;
selecting, based on the difference, an assistance mode from the group consisting of: mistake correcting; and predictive advising;
determining a directive vector based on the assistance mode;
converting the directive vector, using natural language generation (“NLG”), to directive text;
communicating the directive text to a development resource;
providing the directive vector to the platform;
receiving a human reward based on the directive text; and
transmitting the reward to the platform.

17. The method of claim 16 further comprising prior to the communicating, performing a complexity analysis on the directive text.

18. The method of claim 16 further comprising prior to the communicating, performing a coherence analysis on the directive text.

19. The method of claim 16 further comprising formulating a reward matrix based on:
a plurality of state vectors; and
a plurality of actions, each action associated with one of the state vectors.

20. The method of claim 19 wherein the determining includes quantifying:
a first reward based on the observed action; and
a second reward based on the preferred action.

21. The method of claim 20 further comprising computing the second reward using a recurring neural network that includes the human reward.
